(19) United States
(12) Patent Application Publication
(10) Pub. No.: US 2005/0276985 A1
(43) Pub. Date: Dec. 15, 2005

(54) Composite article having a tie layer and method of making the same

(76) Inventors: Mark W. Muggli, West St. Paul, MN (US); Brian E. Spiewak, Inver Grove Heights, MN (US); Craig R. Hoff, Corcoran, MN (US); Katherine A.S. Graham, Roseville, MN (US); Kevin J. Doyle, Woodbury, MN (US); Maria P. Dillon, St. Paul, MN (US); Mark J. Williams, Cottage Grove, MN (US); Todd R. Williams, Lake Elmo, MN (US); Travis B. Hoium, Moorhead, MN (US); Matthew J. Michel, St. Paul, MN (US)

Correspondence Address: 3M INNOVATIVE PROPERTIES COMPANY, PO BOX 33427, ST. PAUL, MN, 55133-3427, US

(21) Appl. No.: 10/864,838

(22) Filed: Jun. 9, 2004

(51) Int. Cl. B32B 27/08

(52) U.S. Cl. 428/421; 428/520

(57) ABSTRACT

Composite articles have two polymeric layers of different compositions bonded together by adhesive and mechanical means.

### BACKGROUND

Fluoropolymer-containing composite articles such as films and tubing are widely used in application wherein inertness and/or chemical barrier properties are desired. Such composite articles typically have a fluoropolymer layer bonded to a layer of a conventional non-fluorinated organic polymer. Examples of such composite articles include fuel tank liners and hoses.

Due to the different physical properties of fluoropolymers and non-fluorinated organic polymers, additional steps are typically carried out in order to achieve a sufficient degree of bonding between the fluoropolymer layer and the non-fluorinated polymer layer that problems of delamination during storage or use are reduced or overcome. Various methods are often used to enhance interlayer adhesion between fluoropolymers and non-fluorinated organic polymers.

One conventional method for enhancing adhesion between fluoropolymers and non-fluorinated organic polymers involves the use of a tie layer. A tie layer is generally a layer of material that exhibits a level of adhesion to both the fluoropolymer and the non-fluorinated organic polymer that is greater than the level of adhesion between the directly bonded fluoropolymer and non-fluorinated organic polymer.

Another method for enhancing adhesion between fluoropolymers and non-fluorinated polymers involves forming shaped features such as dovetails at the fluoropolymer-non-fluorinated polymer interface that mechanically interlock the two polymers.

### SUMMARY

In one aspect, the present invention provides a composite article comprising:
a first polymeric layer having first and second opposed surfaces, the first polymeric layer having a base with a plurality of overhanging protrusions extending therefrom, the base and protrusions together defining the first surface;
a tie layer disposed on and substantially conforming to at least a portion of the first major surface of the first polymeric layer; and
a second polymeric layer having first and second opposed surfaces, wherein the first surface of the second polymeric layer contacts the tie layer;
wherein one of the first or second polymeric layers comprises at least 50 percent by weight of fluoropolymer and the other polymeric layer comprises less than 50 percent of fluoropolymer; wherein the first polymeric layer, second polymeric layer, and tie layer each consist of a different composition; and wherein at least one of the tie layer or the first surface of the second polymeric layer substantially conforms to at least a portion of the base.

In one embodiment, the first surface of the second polymeric layer substantially conforms to the second surface of the tie layer and does not contact the first surface of the first polymeric layer.

In another embodiment, the first surface of the second polymeric layer substantially conforms to the second surface of the tie layer and a portion of the first surface of the first polymeric layer.

In another aspect, the present invention provides a method of making a composite article comprising:
providing a first polymeric layer, the first polymeric layer having a base with a plurality of overhanging protrusions extending therefrom, the base and protrusions together defining a first surface;
disposing a tie layer onto at least a portion of the first surface of the first polymeric layer, wherein the first surface of the tie layer contacts the first surface of the first polymeric layer; and
disposing a second polymeric layer having a first surface and comprising a second polymeric material onto at least a portion of the second surface of the tie layer;
wherein one of the first or second polymeric layers comprises at least 50 percent by weight of fluoropolymer and the other polymeric layer comprises less than 50 percent of fluoropolymer; wherein the first polymeric layer, second polymeric layer, and tie layer each consist of a different composition; and wherein at least one of the tie layer or the first surface of the second polymeric layer substantially conforms to at least a portion of the base.

In one embodiment, the method further comprises disposing the second polymeric layer onto a portion of the first surface of the first polymeric layer.

Composite articles according to the present invention typically exhibit a higher degree of adhesion between the first and second polymeric layers than would be observed by either the tie layer alone (i.e., without overhanging protrusions) or mechanical interlocking alone (i.e., without the tie layer).

As used herein:

“overhanging protrusion” refers to any protrusion wherein at least one point exists within the protrusion from which the shortest line that can be drawn normal to the base is not wholly contained within the protrusion;
“fluoropolymer” means a polymer having at least 10 weight percent fluorine content;
“polymeric layer” refers to a layer comprising at least one polymer;
“substantially conforms to” means intimately contacts at least 75 percent of; and

“thickness” refers to film thickness in the case of films, and to tube wall thickness in the case of tubes.

### BRIEF DESCRIPTION OF THE DRAWING

FIG. 1 is a cut-away perspective view of an exemplary composite film according to the present invention;

FIG. 2 is a cut-away perspective view of an exemplary composite tube according to the present invention;

FIG. 3 is a cut-away perspective view of another exemplary composite film according to the present invention;

FIG. 4 is a cross-sectional schematic view of an exemplary composite article according to the present invention;

FIG. 5 is a cross-sectional schematic view of another exemplary composite article according to the present invention;

FIG. 6 is a cross-sectional photomicrograph of the composite tube of Example 1;

FIG. 7 is a cross-sectional photomicrograph of the composite tube of Example 2; and

FIG. 8 is a cross-sectional photomicrograph of the composite film of Example 3.

### DETAILED DESCRIPTION

Generally, composite articles according to the present invention have a first polymeric layer having first and second opposed surfaces. The first polymeric layer has a base with a plurality of overhanging protrusions extending therefrom. The base and protrusions taken together define the first surface. A tie layer having first and second opposed surfaces is disposed on at least a portion of the first surface of the first polymeric layer, and a second polymeric layer having first and second opposed surfaces is disposed on at least a portion of the second surface of the tie layer.

In one embodiment, at least one of the first or second opposed surfaces of second polymeric layer or tie layer may be a major surface.

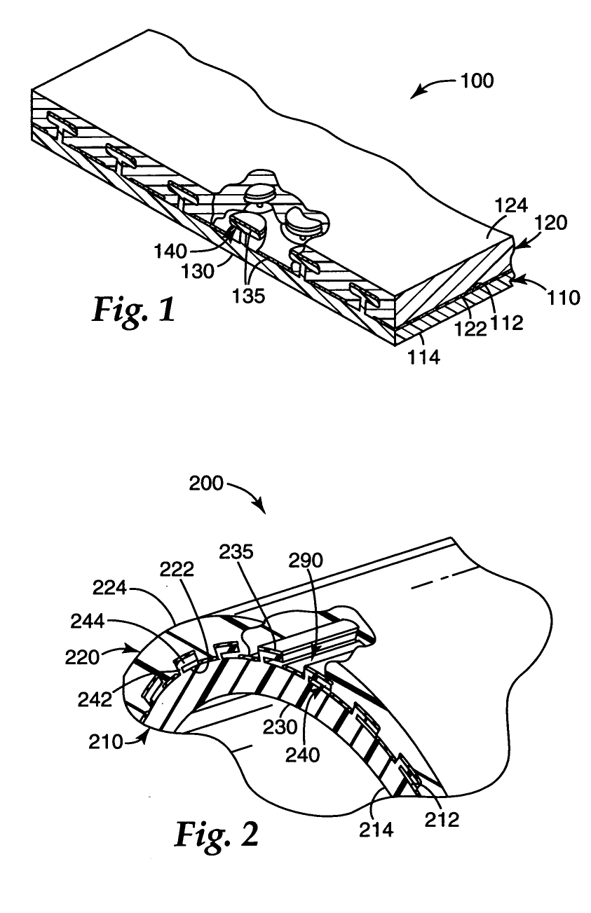

An exemplary composite article is illustrated in FIG. 1. Referring now to FIG. 1, composite film 100 has first polymeric layer 110 and second polymeric layer 120. First polymeric layer 110 has first and second opposed major surfaces 112 and 114, respectively. Discontinuous tie layer 135 is disposed on a portion of first major surface 112. Second polymeric layer 120 is disposed on tie layer 135. First polymeric layer 110 comprises base 130 and a plurality of capped stems 140 that extend from base 130. First major surface 112 is defined by base 130 and the plurality of capped stems 140.

Second polymeric layer 120 has first and second opposed surfaces 122 and 124, respectively, and is disposed on tie layer 135 such that tie layer 135, substantially conforms to first major surface 112, and first surface 122. Tie layer 135 and second polymeric layer 120 contact base 130. A mechanical interlock is formed between first and second polymeric layers 110, 120. First and second polymeric layers 110, 120 comprise first and second polymeric materials, respectively, wherein the first and second polymeric materials are different.

Another exemplary composite article is illustrated in FIG. 2. Referring now to FIG. 2, composite tube 200 has first polymeric layer 210 and second polymeric layer 220. First polymeric layer 210 has first and second opposed major surfaces 212 and 214, respectively. Discontinuous tie layer 235 is disposed on first major surface 212. Second polymeric layer 220 is disposed on discontinuous tie layer 235 and a portion of first major surface 212.

First polymeric layer 210 comprises base 230 and a plurality of parallel, linear overhanging ribs 240 that extend from base 230. First major surface 212 is defined by base 230 and the plurality of overhanging ribs 240. Each overhanging rib 240 comprises a wall portion 242 and one overhang portion 244.

Second polymeric layer 220 has first and second opposed surfaces 222 and 224, respectively, and is disposed on, and substantially conforms to, discontinuous tie layer 235. Tie layer 235 substantially conforms to first major surface 212 and is sufficiently thin that first and second polymeric layers 210, 220 form a mechanical interlock. First and second polymeric layers 210, 220 comprise first and second polymeric materials, respectively, wherein the first and second polymeric materials are different. Tie layer 235 and second polymeric layer 220 contact base 230.

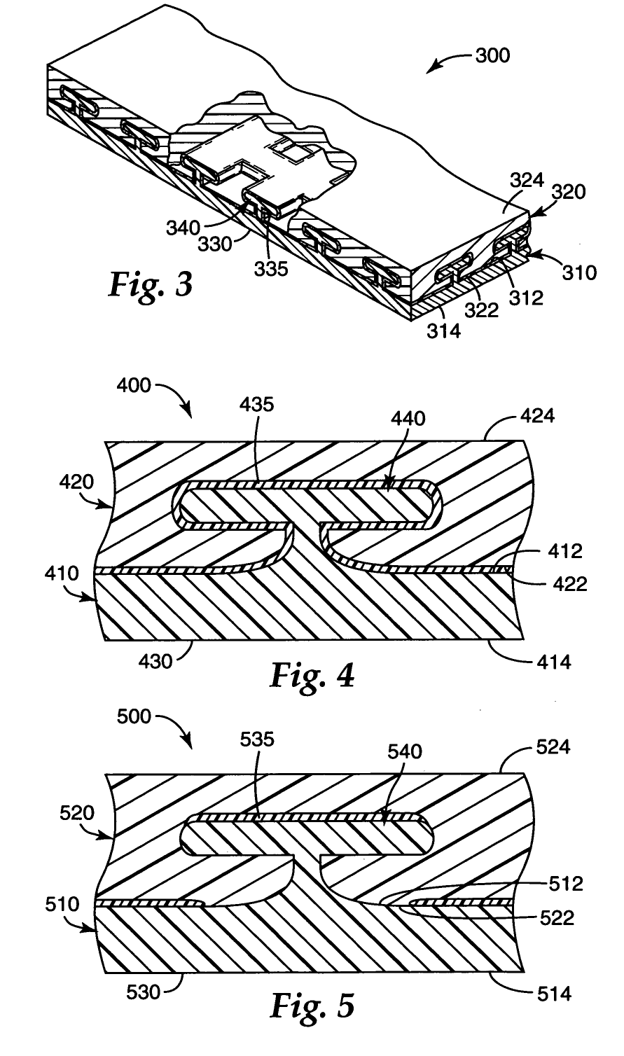

Yet another exemplary composite article is illustrated in FIG. 3. Referring now to FIG. 3, composite film 300 has first polymeric layer 310 and second polymeric layer 320. First polymeric layer 310 has first and second opposed major surfaces 312 and 314, respectively. Continuous tie layer 335 is disposed on first major surface 312. Second polymeric layer 320 is disposed on tie layer 335 and a portion of first major surface 312. First polymeric layer 310 comprises base 330 and a plurality of intersecting overhanging ribs 340 extend from base 330. First major surface 312 is defined by base 330 and the plurality of intersecting overhanging ribs 340.

Second polymeric layer 320 has first and second opposed surfaces 322 and 324, respectively, and is disposed on, and substantially conforms to, tie layer 335. Tie layer 335 substantially conforms to first major surface 312 and is sufficiently thin that first and second polymeric layers 310, 320 form a mechanical interlock. First and second polymeric layers 310, 320 comprise first and second polymeric materials, respectively, wherein the first and second polymeric materials are different. Tie layer 335 and second polymeric layer 320 contact base 330.

Composite articles of the present invention may be used in applications in which attributes (e.g., cost, physical strength, and/or gas and/or liquid diffusion barrier properties) of the first and/or second polymeric layer are important. In such cases, the attribute(s) typically depends on the minimum thickness of the pertinent polymeric layer. Generally, in such cases, it is desirable that the overhanging protrusions have a small height in relation to the overall thickness of the composite article such that maximum and relatively uniform film thickness of the first and second polymeric layers may be maintained. Accordingly, one, two, three, four, ten, or even more overhanging protrusions may have a height, with respect to a vertical line taken normal to the base, that is less than 20 percent or even less than 10 percent of the maximum thickness of the composite article.

Composite articles according to the present invention may have a thickness of less than or equal to 1000 micrometers, 150 micrometers, 100 micrometers, 50 micrometers, or even less than or equal to 5 micrometers, although the thicknesses outside of this range are also useful.

The overhanging protrusions may have any shape or combination of shapes such as for example, arcuate stems, capped stems, intersecting overhanging (e.g., T-shaped or r-shaped) ribs, non-intersecting overhanging ribs, and combinations thereof.

At least a portion of the overhanging protrusions may be irregularly (e.g., randomly) and/or regularly positioned on the base according to a predetermined pattern, for example, at a spacing of less than or equal to about one millimeter.

In one embodiment, at least one of the second surfaces of the first and second polymeric layers may be at least substantially smooth and/or planar. In another embodiment, at least one of the second surfaces of the first and second polymeric layers may have recognizable topographic variation, for example, random surface roughening and/or predetermined topographical features (e.g., pins, wells, ribs, channels, designs).

The first and second polymeric layers may be of any relative thickness, for example, they may be of substantially equal average thickness, or they may be of unequal average thickness.

In one embodiment, the first and second polymeric layers may have regions consisting of different, typically compatible, polymeric materials. For example, the first polymeric layer may have a base portion consisting of one polymeric material, and overhanging protrusions consisting of another compatible polymeric material. Alternatively or in addition, the first and/or second polymeric layers may have regions of one polymeric material encased in a second polymeric material (e.g., as in the case of a semi-interpenetrating polymer network).

For many composite articles such as, for example, films and tubes, the second surfaces of the first and second polymeric layers are typically smoother than the first surface of the first polymeric layer.

The first and second polymeric layers comprise different polymeric materials, typically including at least one thermoplastic organic polymer in each layer. In some embodiments, the first and second polymeric materials may be at least substantially incompatible.

Any thermoplastic material(s) may be used in either layer of the composite articles of the present invention, as long as one of the first or second polymeric layers comprises at least 50 percent by weight (e.g., at least 60, 70, 80, or 90 percent by weight, or more) of fluoropolymer and the other polymeric layer comprises less than 50 percent by weight of fluoropolymer. Although any polymeric material may be used in practice of the present invention, typically at least one of the first and second polymeric materials consists of thermoplastic material at some point during manufacture.

Examples of suitable thermoplastic materials include polyamides and modified polyamides (e.g., nylon-6, nylon-6,6, nylon-11, nylon-6,12, nylon-6,9, nylon-4, nylon-4,2, nylon-4,6, nylon-7, nylon-8, and nylon-12), polyolefins (e.g., homopolymers of polyethylene or propylene), as well as copolymers of these monomers with acrylic monomers and other ethylenically unsaturated monomers such as vinyl acetate and higher alpha-olefins, polyesters, polycarbonates (e.g., polyestercarbonates, polyethercarbonates, and bisphenol A derived polycarbonates), polyurethanes (e.g., aliphatic, cycloaliphatic, aromatic, and polycyclic polyurethanes), polysiloxanes, poly(meth)acrylates (e.g., polymers of acrylic acid, methyl acrylate, ethyl acrylate, acrylamide, methacrylic acid, methyl methacrylate, and/or ethyl methacrylate), polyarylates, polyvinyls, polyethers, cellulosics, polyimides (e.g., polyimide polymers made from the anhydride of pyromellitic acid and 4,4′-diaminodiphenyl ether available from E.I. du Pont de Nemours and Company, Wilmington Del. under the trade designation “KAPTON”), fluoropolymers, polyketones, polyureas, thermoplastic elastomers (e.g., thermoplastic polyurethanes, styrene-butadiene copolymers, styrene-isoprene copolymers), and combinations thereof.

Useful fluoropolymers may be perfluorinated or only partially fluorinated. Useful fluoropolymers include, for example, those that are preparable (e.g., by free-radical polymerization) from monomers comprising chlorotrifluoroethylene, 2-chloropentafluoropropene, 3-chloropentafluoropropene, vinylidene fluoride, trifluoroethylene, tetrafluoroethylene, 1-hydropentafluoropropene, 2-hydropentafluoropropene, 1,1-dichlorofluoroethylene, dichlorodifluoroethylene, hexafluoropropylene, vinyl fluoride, a perfluorinated vinyl ether (e.g., a perfluoro(alkoxy vinyl ether) such as CF₃OCF₂CF₂CF₂OCF═CF₂, or a perfluoro(alkyl vinyl ether) such as perfluoro(methyl vinyl ether) or perfluoro(propyl vinyl ether)), cure site monomers such as for example nitrile containing monomers (e.g., CF₂═CFO(CF₂) LC_{N}, CF₂═CFO [CF₂CF(CF₃)O]_{q}(CF₂O)_{y}CF(CF₃)CN, CF₂═CF[OCF₂CF(CF₃)]ᵣO(CF₂)ₙCN, CF₂═CFO(CF₂)ᵤOCF(CF₃)CN where L=2-12; q=0-4; r=1-2; y=0-6; t=1-4; and u=2-6), bromine containing monomers (e.g., Z-R_{f}—Oₓ—CF═CF₂, wherein Z is Br or I, R_{f} is a substituted or unsubstituted C₁-C₁₂ fluoroalkylene, which may be perfluorinated and may contain one or more ether oxygen atoms, and x is 0 or 1); or a combination thereof, optionally in combination with additional non-fluorinated monomers such as, for example, ethylene or propylene. Specific examples of such fluoropolymers include polyvinylidene fluoride; terpolymers of tetrafluoroethylene, hexafluoropropylene and vinylidene fluoride; copolymers of tetrafluoroethylene, hexafluoropropylene, perfluoropropyl vinyl ether, and vinylidene fluoride; tetrafluoroethylene-hexafluoropropylene copolymers; tetrafluoroethylene-perfluoro(alkyl vinyl ether) copolymers (e.g., tetrafluoroethylene-perfluoro(propyl vinyl ether)); and combinations of thereof.

Useful commercially available fluoropolymers include, for example, those marketed by Dyneon LLC under the trade designations “THV” (e.g., “THV 220”, “THV 400G”, “THV 500G”, “THV 815”, and “THV 610X”), “PVDF”, “PFA”, “HTE”, “ETFE”, and “FEP”; those marketed by Atochem North America, Philadelphia, Pa. under the trade designation “KYNAR” (e.g., “KYNAR 740”); those marketed by Ausimont, USA, Morristown, N.J. under the trade designations “HYLAR” (e.g., “HYLAR 700”) and “HALAR ECTFE”.

The first and/or second polymeric layers and/or tie layer may optionally comprise one or more additional components such as, for example, stabilizers, antioxidants, pigments, plasticizers, UV absorbers, tackifiers, flow control agents, fillers, processing aids, adhesion promoters, colorants, glass bubbles, static control additives (e.g., carbon black), and/or thixotropes.

A tie layer is disposed on at least a portion of the first surface of the first polymeric layer.

In one embodiment, as illustrated, for example, in FIG. 4, composite article 400 has first and second polymeric layers 410 and 420. First polymeric layer 410 has first and second opposed major surfaces 412 and 414. Second polymeric layer 420 has first and second opposed major surfaces 422 and 424. Continuous tie layer 435 is disposed on first major surface 412 and contacts substantially the entirety of first major surface 412 and first surface 422. First major surface 412 is defined by base 430 and overhanging non-intersecting ribs 440.

In another embodiment, as illustrated, for example, in FIG. 5, composite article 500 has first and second polymeric layers 510 and 520. First polymeric layer 510 has first and second opposed major surfaces 512 and 514. Second polymeric layer 520 has first and second opposed major surfaces 522 and 524. Discontinuous tie layer 535 is disposed on first major surface 512 and contacts only a portion of the first major surface 512 and first surface 522. First surface 512 is defined by base 530 and overhanging protrusions 540. The tie layer may be thermoplastic or not, depending on the chemistry of the tie layer, and as long as it adheres the first and second polymeric layers together. Typically, the specific choice of tie layer will be influenced by the chemical nature of the first and second polymeric layers. Examples of useful materials that can be used to form tie layers include monoamines and polyamines as described in, for example, U.S. Pat. No. 5,656,121 (Fukushi), U.S. Pat. No. 5,827,587 (Fukushi), U.S. Pat. No. 5,855,977 (Fukushi et al.), U.S. Pat. No. 5,658,670 (Fukushi et al.), U.S. Pat. No. 6,074,719 (Fukushi et al.); blends of fluoropolymers as described, for example, in U.S. Pat. No. 5,441,782 (Kawashima et al.); U.S. Patent Application Publication Nos. U.S. 2003/0198769 A1 (Jing et al.) and U.S. 2003/0198771 A1 (Fukushi et al.); blends of fluoropolymers with pendant amines as described, for example, in U.S. Pat. No. 6,117,508 (Parsonage et al.), U.S. Pat. No. 6,077,609 (Blong et al.), U.S. Pat. No. 6,362,641 (Shida); fluoroelastomers as described, for example, in U.S. Publication No. 2003/0207118; bases and onium compounds with polyolefins as described, for example, in U.S. Pat. No. 6,096,428 (Jing et al.); radiation-activated compounds as described, for example, in U.S. Pat. No. 6,630,047 (Jing et al.), U.S. Pat. No. 6,685,793 (Jing), and U.S. Patent Application Publication No. U.S. 2004/0058161 A1 (Jing et al.); organic hydrides as described, for example, in WO 2003037621 A2 (Govaerts et al.); silanes as described, for example, in U.S. Pat. No. 5,882,466 (Grootaert et al.); sulfonamides as described, for example, in U.S. Pat. No. 5,284,611 (Grootaert et al.), U.S. Pat. No. 5,478,652 (Grootaert et al.), and U.S. Pat. No. 5,500,042 (Grootaert et al.); bases with polymers with pendant phenolic groups as described, for example, in U.S. Pat. No. 6,346,328 (Parsonage et al.); and combinations thereof, wherein the disclosures of which foregoing patents and publications are incorporated herein by reference.

The tie layer may have a substantially uniform thickness or may vary in thickness, for example, as a result of specific design or manufacturing method. Depending on the thickness of the tie layer, the second polymeric layer may mechanically interlock with at least one overhanging protrusion of the first polymeric layer, or not. Typically, if the second polymeric layer mechanically interlocks with the first polymeric layer, the tie layer will have a thickness substantially smaller than the height of the overhanging protrusion. For example, the tie layer may have a maximum thickness that is less than 10 percent, 5 percent, or even less than 1 percent of the maximum height of the overhanging protrusions, or in some cases, the maximum thickness of the composite article.

Composite articles according to the present invention can be made according to a variety of methods.

In one embodiment, the tie layer and at least one of the first and/or second polymeric layers may be coextruded. For example, the first polymeric layer, the tie layer, and optionally, the second polymeric layer may be simultaneously coextruded using a profile co-extrusion die, for example, according to methods described in concurrently filed U.S. Pat. Appln. No. ______ entitled “MECHANICAL INTERLOCKING DIE” and bearing Attorney Case No. 59561US002, or U.S. Pat. No. 6,447,875 (Norquist et al.), the disclosures of which are hereby incorporated by reference, optionally with subsequent application of pressure (e.g., by a nip roll) while in the molten state. In this procedure, height of the composite film and the ribs is typically a function of factors including the die design and web stretching that occurs during handling.

In another embodiment, the composite article may be prepared in a series of steps that include forming the first polymeric layer as a separate step.

The first polymeric layer may be created in a single-step process such as, for example, by profile extrusion, by embossing a polymer film, or by laminating a polymeric scrim to a polymeric film. For example, the first polymeric layer may be created by bonding a thermoplastic scrim having intersecting ribs to a film or tubular base. In this method, the scrim may be, for example, of the same material of the base, or a different material that is bondable to the base, for example, by heating, or application of radiant or ultrasonic energy. The ribs may have overhanging features when bonded to the base, and/or they may be deformed to create overhanging ribs after attachment to the base, for example, by exposure to external energy (e.g., an air knife, infrared radiation, contact with a heated roll or platen). In another exemplary method, the first polymeric layer may be prepared in single step of casting molten polymer into a mold with undercut regions to create, upon removal from the mold, a layer having overhanging ribs on one surface.

The first polymeric layer may also be prepared in multiple steps. For example, the first polymeric layer may be created by a single step process such as profile extrusion, or by a multi-step process by embossing a film or casting molten polymer in a mold to create a layer having non-overhanging protrusions on one surface, followed by exposing that surface to external energy (e.g., an air knife, infrared radiation, contact with a heated roll or platen) to form them into overhanging protrusions. If desired, discontinuous ribs may be formed, for example, by extruding a layer of thermoplastic material having ribs, slitting the ribs cross-wise to their length, and stretching the layer along their length (e.g., using a wind up roll).

In one exemplary method, the first polymeric layer may be created as a film having an array of outwardly extending capped stems formed by extruding molten polymer into a tool having an array of cylindrical or frustoconical cavities, and then cooled while in contact with the tool. Separation of the cooled polymer film from the tool results in a film of polymer having an array of stems. The stems are subsequently calendered to produce a broader head at the top of the stems. Further details concerning such processes are described, for example, in U.S. Pat. No. 4,056,593 (de Navas Albareda); U.S. Pat. No. 4,290,174 (Kalleberg); U.S. Pat. No. 4,959,265 (Wood et al.); U.S. Pat. No. 5,077,870 (Melbye et al.); U.S. Pat. No. 5,679,302 (Miller et al.); U.S. Pat. No. 5,792,411 (Morris et al.); U.S. Pat. No. 6,039,911 (Miller et al.); and 6,190,594 (Gorman et al.); U.S. Pat. No. 6,372,323 (Kobe et al.); the disclosures of which are incorporated herein by reference.

Further details concerning methods for forming polymeric layers having overhanging protrusions (i.e., the first polymeric layer) may be found, for example, in concurrently filed U.S. Pat. Appln. No. ______ entitled “COMPOSITE ARTICLES AND METHODS OF MAKING THE SAME”, Attorney case number 59620US002, and U.S. Pat. Appln. No. ______ “COMPOSITE ARTICLES AND METHODS OF MAKING THE SAME”, Attorney case number 59703US002, the disclosures of which are incorporated herein by reference.

After forming the first polymeric layer, the tie layer is typically applied to at least a portion of the first major surface of the first polymeric layer. Typically, the specific method chosen will depend on the desired thickness and placement of the tie layer, and the material properties of the tie layer. For example, the tie layer may be applied by extrusion in the case of polymeric tie layers, or it may be coated in undiluted form or as a solution in optional solvent by methods including, for example, spraying, roll coating, gravure coating, curtain coating, knife coating, and bar coating. If the tie layer is applied (e.g., coated) using optional solvent, the solvent is typically at least partially removed, for example, by heating prior to applying the second polymeric layer.

Depending on the chemical nature of the tie layer, it may require an activation step, such as for example, heating and/or exposure to actinic radiation. If so, these steps may be performed at any point in the fabrication process.

The second polymeric layer is then applied to at least a portion of the tie layer and, optionally, any portion(s) of the first major surface of the first polymeric layer not contacted by the tie layer. Useful methods for applying the second layer include, for example, solvent casting, powder coating, and extrusion methods. Additional process steps such as, for example, calendering, embossing, stretching may also be used in combination with the above procedures.

Optionally, the composite article may be subjected to additional treatments that at least partially crosslink the first and/or second polymeric layers. Such treatments are well known and include, for example, heating, especially if the first and/or second polymeric layer further comprises a thermal crosslinking agent, and ultraviolet and/or electron beam radiation. Further details concerning crosslinking of polymeric materials may be found in, for example, U.S. Pat. No. 6,652,943 (Tukachinsky et al.), the disclosure of which is incorporated herein by reference, and PCT Patent Publication WO 200196487 A 1 (Suwa et al.).

Composite articles according to the present invention may have many useful forms including, for example, tubes (including hoses and pipes), blow molded articles (including bottles and bags), injection molded articles, and films (including sheets and rolls). Specific examples include fuel hoses, protective films, and fuel tank liners.

Objects and advantages of this invention are further illustrated by the following non-limiting examples, but the particular materials and amounts thereof recited in these examples, as well as other conditions and, details, should not be construed to unduly limit this invention.

### EXAMPLES

These examples are merely for illustrative purposes only and are not meant to be limiting on the scope of the appended claims. All parts, percentages, ratios, etc. in the examples and the rest of the specification are by weight, unless noted otherwise.

Unless otherwise noted, all reagents used in the examples were obtained, or are available, from general chemical suppliers such as, for example, Sigma-Aldrich Company (Saint Louis, Mo.), or may be synthesized by conventional methods.

Peel Strength Test

Peel strength measurements are determined as follows:

A 0.5-inch (1.3 cm) wide strip of sample (at least 1 inch (2.5 cm) in length) to be tested is prepared. In the case of a tube sample, the tube is slit along its length prior to preparing the strip.

A crack (1.3 cm minimum length) is initiated between the layers between which peel adhesion is to be measured.

Each layer is placed in a opposed clamp of an Instron Tensile Tester (model 5564) obtained from Instron Corporation, Canton, Mass.

Peel strength was measured at a crosshead speed of 150 millimeters/minute as the average load for separation of the two layers.

Reported peel strengths represent an average of at least two samples.

The following abbreviations are used throughout the examples: m=meter, cm=centimeter, mm=millimeter, min=minute, rpm=revolutions per minute, psi=pounds per square inch, and MPa=megapascals.

The following abbreviations are used for materials used in the examples.

| ABBREVI- | |
|---|---|
| ATION | DESCRIPTION |
| FP1 | a copolymer of tetrafluoroethylene, hexafluoropropylene, |
| | vinylidene fluoride and perfluoropropyl vinyl ether, Tₘ = |
| | 230° C., available under the trade designation “VFEPX |
| | 6815G” from Dyneon, LLC |
| NY1 | a mixture of 98 parts of nylon 12 (available under the trade |
| | designation “GRILAMID L25W40X” from EMS Chemie, |
| | Domat, Switzerland), 1 part of Na₂S.9H₂O, and 1 part |
| | tetrabutylphosphonium bromide. |
| NY2 | nylon 12 available under the trade designation “RDS 4357 |
| | BLACK” from EMS Chemie |
| FILM A | FILM A was prepared according to the following pro- |
| | cedure. High density polyethylene (available under the trade |
| | designation “HDPE H2104” from Huntsman Polymers, |
| | Houston, Texas) was extruded from a 2.5-inch (6.4-cm) |
| | single screw extruder at 39 rpm at a temperature range |
| | ramping from 350 to 425° F. (177 to 218° C.) into the cavi- |
| | ties of a mold maintained at 60° F. (16° C.) while moving a |
| | continuous surface of the mold, in which the cavities were |
| | recessed, at a speed of 50 feet/mm (15 m/min). The mold |
| | had a square array of cavities, 0.68 mm apart in each |
| | direction along the surface of the mold (i.e. a density of |
| | 1400 cavities per square inch (217 cavities/cm²)). Each of |
| | the cavities was uniformly tapered and had a diameter of |
| | 0.26 mm at a depth of 0.05 mm, and a diameter of 0.26 mm |
| | at a depth of 0.15 mm, and was 1.4 mm deep. The resin |
| | was pressed into the cavities by a roller along the surface |
| | of the mold. The roller had a temperature of 80° F. |
| | (27° C.). The resin solidified in the mold and was stripped |
| | away from the mold as a web having an array of upstanding |
| | stems 300 micrometers long, and having a film base thick- |
| | ness of 5 mils (130 micrometers). |

### Example 1

Example 1 was a composite tube having three layers: the first layer (i.e., innermost layer) was FP1, the tie layer was NY1, and the second layer is NY2. It was prepared using a Guill model 523 (Guill Tool and Engineering Co., Inc., West Warwick, R.I.) three-layer in-line extrusion head, and equipped with a wedge ring as shown in FIG. 1 of concurrently filed U.S. Pat. Appln. No. ______ entitled “MECHANICAL INTERLOCKING DIE” bearing Attorney Case No. 59561US002 (central orifice was 0.76 inch (19 mm), incorporated herein by reference)

To form the first layer, FP1 was profile extruded using a 1.5-inch (3.8-cm) single screw extruder available from Harrel, Inc., East Norwalk, Conn. (Temp Profile: zone 1=250° C., zone 2=265° C., zone 3=280° C.). The tie layer was extruded onto the first layer while it was still within the extrusion head using a 1.0-inch (2.5 cm) single screw extruder available from Harrel, Inc. (Temp Profile: zone 1=180° C., zone 2=200° C., zone 3=200° C.). Next the second layer was extruded onto the tie layer while it was still within the extrusion head using a 2.0-inch (5.1-cm) single screw extruder available from Harrel, Inc. (Temp Profile: zone 1=180° C., zone 2=200° C., zone 3=200° C., zone 4=210° C.). The extrudate exited a tube die having 0.866-inch (2.20-cm) diameter orifice at a line speed of 20 feet/min (6.1 m/min) and was quenched using a vacuum water chamber.

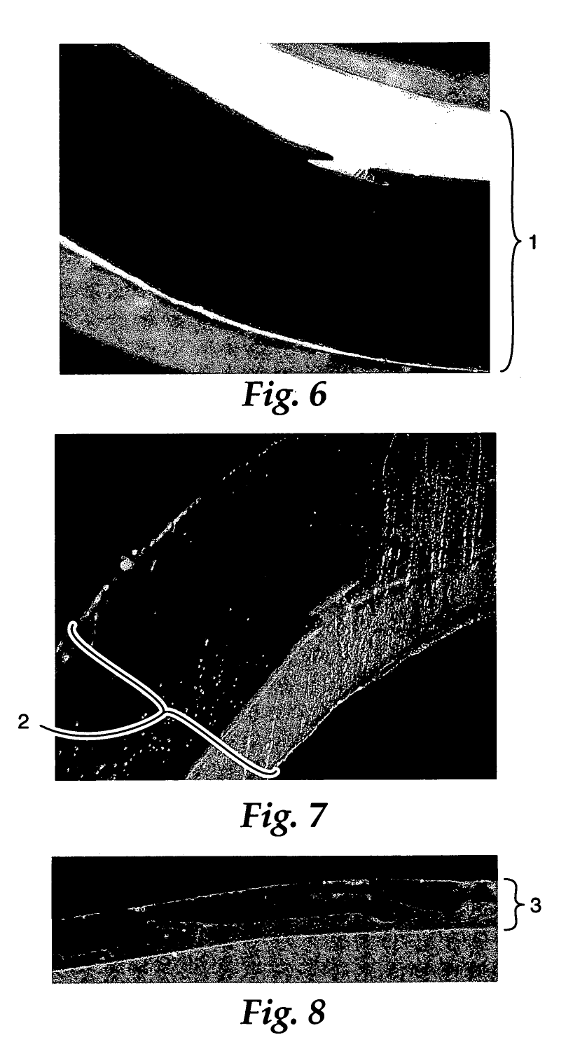

The resultant composite tube 1, which had a nominal inner diameter of 6 mm and a nominal outer diameter of 8 mm, is shown in FIG. 6.

### Example 2

Example 2 was conducted according to the procedure of Example 1, except that the line speed was 50 feet/min (15 m/min). The resultant composite tube 2, which had a nominal inner diameter of 6 mm and a nominal outer diameter of 8 mm, is shown in FIG. 7.

Peel strengths along the longitudinal direction of the profile features (i.e., the rib direction) were measured according to the PEEL STRENGTH TEST. Results are reported in Table 1 (below), wherein Peel Strengths represent averages of 4-6 measurements.

TABLE 1

| | Peel Strength, |
|---|---|
| Example | Newtons per square meter |
| Example 1 | 36 |
| Example 2 | 41 |

### Example 3

A tie layer of 1 part polyethyleneimine, 1 part water, and 98 parts methyl ethyl ketone was coated onto the side of FILM A with the stems. The tie layer-coated side of FILM A was repeatedly flood coated with a solution of fluoropolymer (available under the trade designation “THV 220” from Dyneon, LLC). The solution was a 20 percent weight/weight solution of fluoropolymer in acetone. After each coating the solvent was removed. The coating procedure was repeated until a sufficient thickness of fluoropolymer was built up to cover the stems of FILM A. The coated film was further processed by pressing it at 300 psi (2.07 MPa) while heating at 135° C. for 1 minute using a Wabash heated hydraulic press. The resultant composite film 3, as shown in FIG. 8, had a thickness of 8 mils (200 micrometers). The peel strength for composite film 3 (measured according to the PEEL STRENGTH TEST) was 9.3 Newtons/centimeter.

Various modifications and alterations of this invention may be made by those skilled in the art without departing from the scope and spirit of this invention, and it should be understood that this invention is not to be unduly limited to the illustrative embodiments set forth herein.

1. A composite article comprising:
a first polymeric layer having first and second opposed surfaces, the first polymeric layer having a base with a plurality of overhanging protrusions extending therefrom, the base and protrusions together defining the first surface;
a tie layer disposed on and substantially conforming to at least a portion of the first major surface of the first polymeric layer; and
a second polymeric layer having first and second opposed surfaces, wherein the first surface of the second polymeric layer contacts the tie layer;
wherein one of the first or second polymeric layers comprises at least 50 percent by weight of fluoropolymer and the other polymeric layer comprises less than 50 percent of fluoropolymer; wherein the first polymeric layer, second polymeric layer, and tie layer each consist of a different composition; and wherein at least one of the tie layer or the first surface of the second polymeric layer substantially conforms to at least a portion of the base.

2. A composite article according to claim 1, wherein the first surface of the second polymeric layer contacts the tie layer and does not contact the first major surface of the first polymeric layer.

3. A composite article according to claim 1, wherein the first surface of the second polymeric layer contacts the tie layer and a portion of the first surface of the first polymeric layer.

4. A composite article according to claim 1, wherein at least one of the first or second polymeric layers comprises at least one thermoplastic polymer.

5. A composite article according to claim 1, wherein at least one of the first or second polymeric layers comprises at least one polymer that is at least partially crosslinked.

6. A composite article according to claim 1, wherein the overhanging protrusions extend from the base at predetermined positions.

7. A composite article according to claim 1, wherein the overhanging protrusions extend from the base according to a repeating pattern.

8. A composite article according to claim 1, wherein the overhanging protrusions comprise at least one of overhanging ribs or capped stems.

9. A composite article according to claim 1, wherein the overhanging protrusions comprise a network of intersecting overhanging ribs.

10. A composite article according to claim 1, wherein the composite article has a maximum thickness of less than or equal to about 0.5 millimeters.

11. A composite article according to claim 1, wherein the tie layer contacts substantially the entire first major surface of the first polymeric layer and the first surface of the second polymeric layer.

12. A composite article according to claim 1, wherein the second polymeric layer mechanically interlocks with at least one overhanging protrusion.

13. A composite article according to claim 1, wherein at least one of the second major surface of the first polymeric layer or the second surface of the second polymeric layer is smoother than the first major surface of the first polymeric layer.

14. A composite article according to claim 1, wherein the tie layer comprises thermoplastic material.

15. A composite article according to claim 1, wherein the tie layer has substantially uniform thickness.

16. A composite article according to claim 1, wherein the tie layer has a maximum thickness that is less than 10 percent of the maximum thickness of the composite article.

17. A composite article according to claim 1, wherein at least one protrusion has a height of less than about 100 micrometers.

18. A composite article according to claim 1, wherein the composite article has a maximum thickness, wherein no protrusion has a height, with respect to a vertical line taken normal to the base, that is greater than 20 percent of the maximum thickness of the composite article.

19. A composite article according to claim 1, wherein the composite article has a maximum thickness, wherein no protrusion has a height, with respect to a vertical line taken normal to the base, that is greater than 10 percent of the maximum thickness of the composite article.

20. A composite article according to claim 1, wherein the fluoropolymer is preparable from monomers comprising chlorotrifluoroethylene, vinylidene difluoride, tetrafluoroethylene, hexafluoropropylene, perfluoro(methyl vinyl ether), perfluoro(propyl vinyl ether), vinyl fluoride, or a combination thereof.

21. A composite article according to claim 1, wherein one of the first or second polymeric layers comprises at least one polyamide, polyolefin, polyester, polyimide, or a combination thereof.

22. A composite article according to claim 1, wherein the composite article comprises a tube.

23. A composite article according to claim 1, wherein the composite article comprises a film.

24. A method of making a composite article comprising:
providing a first polymeric layer, the first polymeric layer having a base with a plurality of overhanging protrusions extending therefrom, the base and protrusions together defining a first surface;
disposing a tie layer onto at least a portion of the first surface of the first polymeric layer, wherein the first surface of the tie layer contacts the first surface of the first polymeric layer; and
disposing a second polymeric layer having a first surface and comprising a second polymeric material onto at least a portion of the second surface of the tie layer;
wherein one of the first or second polymeric layers comprises at least 50 percent by weight of fluoropolymer and the other polymeric layer comprises less than 50 percent of fluoropolymer; wherein the first polymeric layer, second polymeric layer, and tie layer each consist of a different composition; and wherein at least one of the tie layer or the first surface of the second polymeric layer substantially conforms to at least a portion of the base.

25. A method according to claim 24, further comprising disposing the second polymeric layer onto a portion of the first major surface of the first polymeric layer.

26. A method according to claim 24, wherein at least one of the first or second polymeric layers comprises at least one thermoplastic polymer.

27. A method according to claim 24, wherein at least one of the first or second polymeric layers comprises at least one polymer that is at least partially crosslinked.

28. A method according to claim 24, wherein the tie layer and at least one of the first and second polymeric layers is coextruded.

29. A method according to claim 24, wherein the tie layer, first polymeric layer, and second polymeric layer are coextruded.

30. A method according to claim 24, further comprising exposing the tie layer to actinic radiation.

31. A method according to claim 24, further comprising heating the composite article.

32. A method according to claim 24, further comprising at least partially crosslinking at least one of the first or second polymeric materials.
